(19) United States
(12) Patent Application Publication
(10) Pub. No.: US 2009/0162574 A1
(43) Pub. Date: Jun. 25, 2009

(54) Method for making light metal-based nano-composite material

(75) Inventors: Nai-Yi Li, Tu-Cheng (TW); Tadayoshi Tsukeda, Tokyo (JP); Kuo-Jung Chung, Tu-Cheng (TW); Kam-Shau Chan, Tu-Cheng (TW); Cheng-Shi Chen, Tu-Cheng (TW); Qing-Chun Du, Shenzhen City (CN); Wen-Zhen Li, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 12/313,715

(22) Filed: Nov. 24, 2008

(30) Foreign Application Priority Data
Nov. 23, 2007 (CN) 200710124776.4

(51) Int. Cl. B06B 1/00

(52) U.S. Cl. 427/600

(57) ABSTRACT

A method for fabricating a light metal-based nano-composite material, the method includes the steps of: (a) providing melted metal and nanoscale reinforcements; (b) ultrasonically dispersing the nanoscale reinforcements in the melted metal by means of ultrasonically mixing to achieve a mixture with the nanoscale reinforcements uniformly dispersed therein; and (c) cooling the mixture.

### BACKGROUND

1. Field of the Invention

The present invention relates to methods for fabricating composite materials and, particularly, to a method for fabricating a light metal-based nano-composite material.

2. Discussion of Related Art

Light metals, including magnesium and aluminum, have relatively superior mechanical properties, such as low density, good wear resistance, and high elastic modulus. However, the toughness and strength of the light metals are not able to meet the increasing needs of the automotive and aerospace industry for tougher and stronger materials.

To address the above-described problems, the light metal-based nano-composite materials have been developed. In the light metal-based nano-composite materials, nanoscale reinforcements (e.g. carbon nanotubes or carbon nanofibers) are mixed with the light metals. The most common method for making the light metal-based nano-composite material is through thixomolding and includes the steps of: (a) providing a plurality of light metal particles and nanoscale reinforcements; (b) mixing the light metal particles and nanoscale reinforcements to form a mixture; (c) putting the mixture into a thixomolding machine and heating the mixture to form a semi-solid-state paste; and (d) injecting the semi-solid-state paste into a mold and cooling down the semi-solid-state paste to form the light metal-based nano-composite material. However, in the above-described method, the nanoscale reinforcements are prone to aggregate. As such, the nanoscale reinforcements can't be well dispersed in the light metal.

What is needed, therefore, is to provide a method for fabricating a light metal-based nano-composite material, in which the above problems are eliminated or at least alleviated.

### SUMMARY

In one embodiment, a method for fabricating a light metal-based nano-composite material, the method includes the steps of: (a) providing melted metal and nanoscale reinforcements; (b) ultrasonically dispersing the nanoscale reinforcements in the melted light metal by means of ultrasonically mixing to achieve a mixture with the nanoscale reinforcements uniformly dispersed therein; and (c) cooling the mixture.

Other novel features and advantages of the present method for fabricating the light metal-based nano-composite material will become more apparent from the following detailed description of preferred embodiments when taken in conjunction with the accompanying drawings.

### BRIEF DESCRIPTION OF THE DRAWINGS

Many aspects of the present method for fabricating the light metal-based nano-composite material can be better understood with reference to the following drawings. The components in the drawings are not necessarily to scale, the emphasis instead being placed upon clearly illustrating the principles of the present method for fabricating the light metal-based nano-composite material.

FIG. 1 is a flow chart of a method for fabricating a light metal-based nano-composite material, in accordance with a present embodiment.

FIG. 2 is a schematic view of the light metal-based nano-composite material of FIG. 1.

Corresponding reference characters indicate corresponding parts throughout the several views. The exemplifications set out herein illustrate at least one embodiment of the present method for fabricating the light metal-based nano-composite material, in at least one form, and such exemplifications are not to be construed as limiting the scope of the invention in any manner.

### DETAILED DESCRIPTION OF EXEMPLARY EMBODIMENTS

References will now be made to the drawings to describe, in detail, embodiments of the method for fabricating the light metal-based nano-composite material.

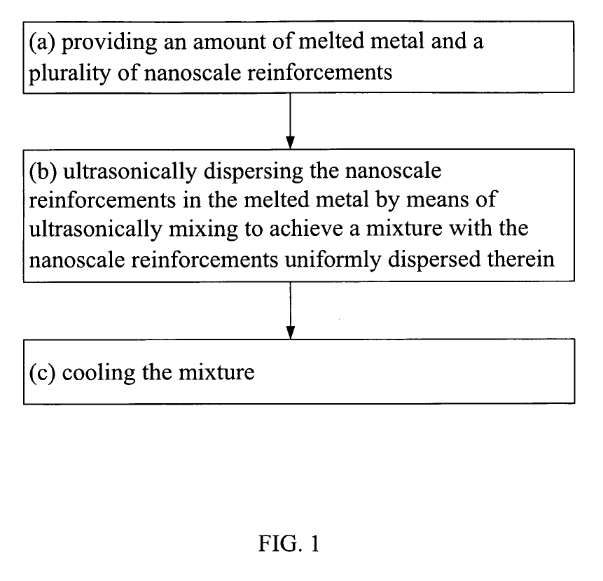

Referring to FIG. 1, a method for fabricating a light metal-based nano-composite material includes the steps of: (a) providing an amount of melted light metal and a plurality of nanoscale reinforcements; (b) dispersing the nanoscale reinforcements in the melted light metal by means of ultrasonically mixing to achieve a mixture with the nanoscale reinforcements uniformly dispersed therein; and (c) cooling the mixture to achieve the light metal-based nano-composite material. It is to be understood that the process can employ all metals.

The above-described steps are all processed in a protective gas to prevent oxidation of the light metal. In step (a), the melted light metal is formed by the substeps of: (a1) putting a plurality of light metal particles into a container; and (a2) heating the container in an oven to 660˜690° C. with a protective gas therein, to form the melted light metal.

The material of the nanoscale reinforcements can be selected from a group consisting of nanoscale carbon, silicon carbide (SiC), alumina (Al₂O₃), titanium carbide (TiC), boron carbide (BC) and combinations thereof. The shape of the nanoscale reinforcements can be selected from a group consisting of nanowire, nanotube, nanorod, nanosphere and combinations thereof. A diameter of the nanoscale reinforcements can be in the approximate range from 1 to 150 nanometers. In the present embodiment, the nanoscale reinforcements are carbon nanotubes, the diameters thereof are about 20 to 30 nanometers.

In step (a1), the material of the light metal can be pure magnesium, pure aluminum, magnesium-based alloys, or aluminum-based alloys. Components of the magnesium-based alloys include magnesium and other elements selected from a group consisting of zinc (Zn), manganese (Mn), aluminum (Al), thorium (Th), lithium (Li), silver, calcium (Ca), and any combination thereof. A weight ratio of the magnesium to the other elements can be about 4:1 or greater. Components of the aluminum-based alloys include aluminum and other elements selected from a group consisting of zinc (Zn), manganese (Mn), magnesium (Mg), thorium (Th), lithium (Li), silver, calcium (Ca), and any combination thereof. A weight ratio of the aluminum to the other elements can be about 4:1 or greater.

In the present embodiment, the material of the light metal is magnesium-based alloy including 85% magnesium and 15% zinc.

In step (a2), the protective gas can be made up of about 70%˜99.5% nitrogen (N₂) and 0.5%˜1.0% fluoride. The nitrogen can be partially, meaning approximately 20%/˜25%, replaced by carbon dioxide (CO₂). In the present embodiment, the protective gas is made up of about 99.3% nitrogen and about 0.7% sulfur hexafluoride.

When the temperature reaches 540° C., the particles of light metal begin to melt. When the temperature is above 640° C., the particles of light metal are entirely melted.

In step (b), the nanoscale reinforcements are put into the melted light metal to form a mixture. Then, the mixture is sonicated at a predetermined frequency in a high power ultrasonic vibrator. In the present embodiment, a wave guide rod is connected to the high power ultrasonic vibrator and immersed into the mixture. The ultrasonic wave is longitudinal wave. The length of the wave guide rod is decided by the wavelength of the ultrasonic wave to obtain a maximum amplitude. According to vibration of the wave guide rod, a plurality of bubbles are created in the mixture. When meeting the aggregations of the reinforcements, bubbles will break and a force of break will disperse the aggregations in the mixture. The mixture can be a liquid with reinforcements dispersed therein or a semi-solid-state paste. The viscosity of the mixture can be adjusted to best achieve the mixing and/or the molding. The viscosity need not be constant throughout the mixing process.

A weight percentage of the nanoscale reinforcements in the mixture can be approximately 2% to 40%. A weight percentage of the light metal in the mixture can be approximately 60% to 98%. In the present embodiment, the weight percentage of the carbon nanotubes in the mixture is about 20%, and the weight percentage of the light metal in the mixture is about 80%.

The frequency of the sonication can be in the approximate range from 15˜20 kHz. A mixing time is about 5˜40 minutes depending on the amount of the mixture. The higher of the sonication frequency, the smaller of the sizes of the bubbles, and the greater of the force created by the bubbles' breaking. However, the amplitude of the wave guide rod is relatively low. The lower of the sonication frequency, the bigger of the sizes of the bubbles, and the weaker of the force created by the bubbles' breaking. However, the amplitude of the wave guide rod is relatively high. In the present embodiment, the frequency is about 15 kHz, and the mixing time is about 30 minutes.

In the present embodiment, the frequency of the sonication is relatively low. The high power ultrasonic vibrator can form a vibration of large amplitude and cause a violent movement of the mixture. As such, the nanoscale reinforcements can be uniformly dispersed in the mixture.

In step (c), the mixture is injected into a mold and cooled down to room temperature. Thus, the mixture is cooled to form the solid light metal-based nano-composite material. Then, the light metal-based nano-composite material can be removed from the mold. The shape of the light metal-based nano-composite material is determined by the shape of the mold. The light metal-based nano-composite material can be cast into a desired shape during step (c).

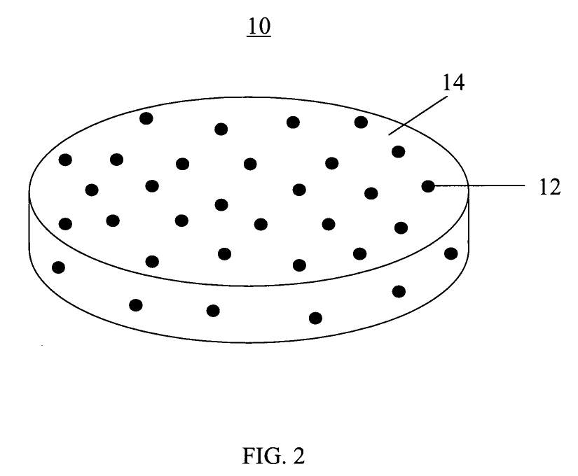

Referring to FIG. 2, in the present embodiment, the mixture is injected into a flat ingot-shaped mold to form a flat ingot-shaped light metal-based nano-composite material 10. In the light metal-based nano-composite material 10, the carbon nanotubes 12 are well dispersed in the light metal 14.

In the present embodiment, the mixture is stirred in a high-powered ultrasonic vibrator. The high power ultrasonic vibrator can form a vibration with large amplitude, and thus, cause a violent movement of the mixture. During the movement, the uniform dispersion of the nanoscale reinforcements in the melted light metal is achieved. The achieved light metal-based nano-composite material is strong, tough, and can be widely used in a variety of fields, such as the automotive and aerospace industries.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

It is also to be understood that above description and the claims drawn to a method may include some indication in reference to certain steps. However, the indication used is only to be viewed for identification purposes and not as a suggestion as to an order for the steps.

What is claimed is:

1. A method for fabricating a light metal-based nano-composite material, the method comprising the steps of:
(a) providing an amount of melted metal and a plurality of nanoscale reinforcements;
(b) ultrasonically dispersing the nanoscale reinforcements in the melted metal by means of ultrasonically mixing to achieve a mixture with the nanoscale reinforcements uniformly dispersed therein; and
(c) cooling the mixture.

2. The method as claimed in claim 1, wherein the steps (a) to (c) are processed in a protective gas, the protective gas comprises nitrogen and fluoride.

3. The method as claimed in claim 2, wherein the volume percentage of the nitrogen in the protective gas is in the approximate range from 70%˜99.5%, and the volume percentage of the fluoride in the protective gas is in the approximate range from 0.5%˜1.0%.

4. The method as claimed in claim 1, wherein the material of the metal is pure magnesium, pure aluminum, magnesium-based alloys, or aluminum-based alloys.

5. The method as claimed in claim 4, wherein components of the magnesium-based alloys comprises magnesium and other elements selected from a group consisting of zinc, manganese, aluminum, thorium, lithium, silver, calcium, and any combination thereof.

6. The method as claimed in claim 5, wherein a weight ratio of the magnesium to the other elements is about 4:1 or greater.

7. The method as claimed in claim 4, wherein components of the aluminum-based alloys include aluminum and other elements selected from a group consisting of zinc, manganese, magnesium, thorium, lithium, silver, calcium, and any combination thereof.

8. The method as claimed in claim 7, wherein a weight ratio of the aluminum to the other elements is about 4:1 or greater.

9. The method as claimed in claim 1, wherein material of the nanoscale reinforcements is selected from a group consisting of nanoscale carbon, silicon carbide, alumina, titanium carbide, boron carbide, and combinations thereof.

10. The method as claimed in claim 1, wherein a shape of the nanoscale reinforcements is selected from a group consisting of nanowire, nanotube, nanorod, nanosphere and combinations thereof, and a diameter of the nanoscale reinforcements is in the approximate range from 1 to 150 nanometers.

11. The method as claimed in claim 1, wherein a weight percentage of the nanoscale reinforcements in the mixture is in the approximate range from 2% to 40%, and a weight percentage of the metal in the mixture is in the approximate range from 60% to 98%.

12. The method as claimed in claim 1, wherein a frequency of the ultrasonically mixing is in the approximate range from 15˜20 kHz.

13. The method as claimed in claim 1, wherein the ultrasonically mixing occurs for about 5˜40 minutes.

14. The method as claimed in claim 1, wherein in step (c), the mixture is cooled down after being injected into a mold.

15. The method as claimed in claim 1, wherein the metal-based nano-composite material is cast into a desired shape during step (c).
